(19) United States
(12) Patent Application Publication
(10) Pub. No.: US 2025/0147806 A1
(43) Pub. Date: May 8, 2025

(54) APPLICATION OF DIGITAL AND QUANTUM ANNEALING TO GATE-BASED QUANTUM COMPUTATION

(71) Applicant: Dell Products L.P., Round Rock, TX (US)

(72) Inventors: Victor Fong, Medford, MA (US); Brendan Burns Healy, Haddonfield, NJ (US); Miguel Paredes Quiñones, Campinas (BR)

(21) Appl. No.: 18/345,410

(22) Filed: Jun. 30, 2023

Related U.S. Application Data
(60) Provisional application No. 63/383,343, filed on Nov. 11, 2022.

(51) Int. Cl. G06F 9/50; G06N 10/40; G06N 10/60

(52) U.S. Cl. CPC G06F 9/5027; G06N 10/40; G06N 10/60

(57) ABSTRACT

One example method includes receiving a user job that includes a quantum computing workload, evaluating the quantum computing workload, based on the evaluating, solving an orchestration optimization problem by identifying a computing resource for execution of the quantum computing workload, and the computing resource is selected from a defined group of computing resources of a computing infrastructure, and orchestrating the quantum computing workload to the computing resource for execution.

### FIELD OF THE INVENTION

Embodiments of the present invention generally relate to quantum computing. More particularly, at least some embodiments of the invention relate to systems, hardware, software, computer-readable media, and methods, for application of digital and quantum annealing to gate-based quantum computation.

### BACKGROUND

Various different types of quantum systems and computation may be employed for solving problems. For example, gate-based quantum computing systems, and quantum annealing systems, each have applicability in various areas. Different computing systems may be especially suited to solve problems of a particular type. Thus, the nature of a problem to be solved may dictate which type of quantum system will be used to solve that problem. Put another way, different quantum computing systems may have different respective strengths and weaknesses.

At present however, gate-based quantum computers and annealing quantum computers tend to exist in respective silos, with no ability on the part of either to leverage the strengths of the other. Further, utilizing classical computing infrastructure to solve optimization problems, such as may be submitted to a broker of cloud-based QPUs (quantum processing units), is inefficient and requires significant resources.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying Figures.

FIG. 1 discloses an architecture according to one example embodiment.

FIG. 2 discloses aspects of methods according to one or more example embodiments.

FIG. 3 discloses a computing entity configured and operable to perform any of the disclosed methods, processes, and operations.

### DETAILED DESCRIPTION OF SOME EXAMPLE EMBODIMENTS

Embodiments of the present invention generally relate to quantum computing. More particularly, at least some embodiments of the invention relate to systems, hardware, software, computer-readable media, and methods, for application of digital and quantum annealing to gate-based quantum computation.

In one example embodiment, gate-based quantum computing, quantum annealing, and a classical computing infrastructure may be merged together to take advantage of the relative strengths of each of the computing approaches when making orchestration decisions regarding quantum workloads, and solving problems. Thus, in an embodiment, the quantum annealing capabilities, whether on-prem or off, may be integrated as an additional resource into a computing platform so that portions of a quantum workload, such as circuit cutting/knitting problems for example, which a quantum annealer is particularly well-suited to handle may be orchestrated to the quantum annealer for resolution. By orchestrating such jobs to a quantum annealer, an embodiment may contribute to an improved QaaS (quantum as a service) experience for the user who submitted the problem.

In an embodiment, a quantum annealer may additionally, or alternatively, operate to solve an orchestration optimization problem that may involve orchestration of a particular problem, such as an NP-hard problem for example, to a gate-based quantum computing infrastructure for resolution. Put another way, a quantum annealer may, in an embodiment, operate to solve a resource allocation problem, such as by orchestrating a quantum workload to a gate-based computing infrastructure that may comprise QPUs and/or vQPUs.

Further information concerning one or more example embodiments of the invention is disclosed in Appendix A hereto. Appendix A forms a part of this disclosure and is incorporated herein in its entirety by this reference.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that the strengths of annealing devices, such as digital annealers and quantum annealers, may be applied to certain elements of a computing workload, such as QUBOs or circuit cutting/knitting problems for example, that the annealing devices are particularly well-suited to handle. As another example, portions of a quantum workload may be orchestrated to the computing resource best suited, as among a group of computing resources, to handle those portions. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Introduction

There are various types of quantum computing systems and approaches, notably, gate-based computing, and annealing. Annealing processes may comprise adiabatic processes performed by quantum computing systems, also referred to as quantum annealing processes, while other annealing processes may comprise real processes performed by digital computing systems. As discussed below, gate-based approaches, and annealing, each have their respective strengths in terms of the tasks they are able to effectively handle.

In particular, gate-based quantum computation excels at specific tasks, such as solving certain NP-hard (non-deterministic polynomial-time hardness) problems including integer factorization, and boolean satisfiability. However, there are areas of technology where gate-based quantum computing will not be revolutionary, or possibly even helpful. Thus, the focus of some participants in the quantum space has been on providing classical computing infrastructure to augment the power of quantum computation and to make the quantum computation more broadly applicable.

In a similar vein, quantum annealing, as well as digital annealing, has its own area of applicability. Annealers such as DWave may handle problems in the QUBO (quadratic unconstrained binary optimization) format. While such problems are, by definition, optimization problems, some non-optimization problems, such as MIP (mixed integer programming), may be converted to a QUBO format for solution. Notwithstanding, some expect that the primary area of applicability for annealing technology will be optimization, at least for the presently foreseeable future.

Note that as used herein, “quantum annealing” includes, but is not limited to, an optimization process for finding the global minimum of a given objective function over a given set of candidate solutions, by a process using quantum fluctuations. Quantum annealing may be used for problems where the search space is discrete with many local minima, such as, for example, finding the ground state of a spin glass, or the traveling salesman problem.

In the interest of augmenting the performance of cloud-based quantum computers via classical infrastructure, some embodiments may find utility in solving certain optimization problems. With this example use case in mind, there arises the opportunity to merge together the power of both kinds of quantum technology, that is, gate-based and annealing, which when taken together with classical infrastructure, may yield systems more powerful than any of the three taken individually.

### B. General Aspects of Some Example Embodiments

An embodiment may employ both gate-based and annealing quantum computers in such a way that the gate-based computers, and quantum computers, are each able to leverage the strengths of the other. By way of example, an embodiment may utilize a quantum computing infrastructure to solve optimization problems, such as may arise in the context of providing services as a broker for cloud-based QPUs, in an efficient way that does not require significant resources.

### C. Example Architecture

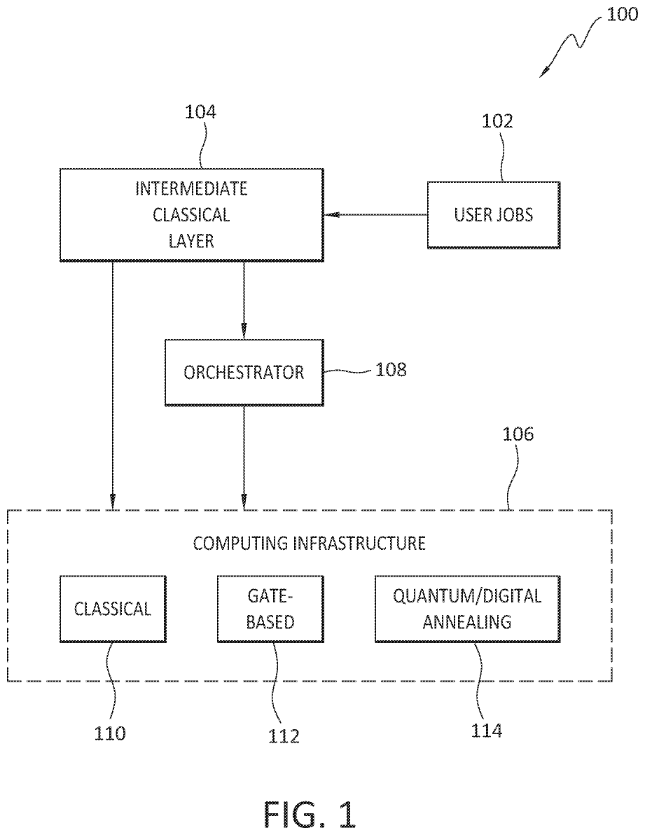

With attention now to FIG. 1, an example architecture according to one embodiment is denoted generally at 100. In this example, a user job 102, such as a quantum computing workload, may be submitted to a computing platform that includes an intermediate classical layer 104. The intermediate classical layer 104 may comprise, and/or be able to access, various classical computing elements and quantum computing elements for the purpose of handling part or all of a user job 102. Depending upon the nature of the user job 102, the intermediate classical layer 104 may allocate, that is, verify and ensure the availability of, various elements of a computing infrastructure 106 for performance of portions of the user job 102.

The intermediate classical layer 104 may also communicate with an orchestrator 108. For example, the intermediate classical layer 104 may forward a user job 102, or a portion thereof, to the orchestrator 108 for orchestration to one or more elements of the computing infrastructure 106 for execution. In an embodiment, the computing infrastructure 106 may comprise classical computing elements 110, gate-based quantum computing elements 112, and one or more annealers 114 which may comprise one or more quantum annealers and/or one or more digital annealers.

In an embodiment, the functionality implemented by any portion, or all of, the computing infrastructure 106 may be provided aaS (as a service) by a service provider. For example, computing services implemented by the gate-based quantum computing elements 112 and/or the computing services implemented by the quantum annealer(s) 114 may constitute QaaS (quantum as a service) made available by a vendor to users or subscribers. In an embodiment, the computing infrastructure 106 may be located at a cloud computing site, such as a vendor site for example, and the functionality of the computing infrastructure 106 offered aaS. In an embodiment, part or all of the computing infrastructure 106 may be located on-premises at a user site.

Operationally, and by way of example, when a user job 102, such as a circuit cutting/knitting job, a QUBO problem, or an MIP problem, for example, comes in that is best suited for execution by a quantum annealer, as opposed to being performed on classical computing elements 110 or gate-based computing elements 112, the orchestrator 108 may provide that user job 102 to the quantum annealer(s) 114 for execution. Thus, in an embodiment, and by way of example, the quantum annealer(s) 114 may serve as an MIP solver for circuit cutting operations, and/or as a QUBO solver. In an embodiment then, the nature of the problem to be solved may inform an orchestration decision.

With continued reference to FIG. 1 and some example operational aspects of one or more embodiments, a user job 102 may comprise a particular problem, such as an NP-hard problem for example, that must be orchestrated to a computing infrastructure that is well suited, or possibly best suited among the available alternatives, to solve the problem. Thus, resolution of the NP-hard problem, in this non-limiting example, implies resolution of another problem first, namely, an orchestration optimization problem whose solution will determine where, that is, on what computing infrastructure, the NP-hard problem will be solved. Once the orchestration optimization problem is solved, the underlying problem, the NP-hard problem in this example, may then be orchestrated to the appropriate computing infrastructure for solution.

With further reference now to the example architecture 200, operations such as those just described may be implemented as follows. As noted above, the user job 102 may comprise a problem that requires a solution. The user job 102 may thus be orchestrated by the orchestrator 108, or provided directly by the intermediate classical layer 104, to the computing infrastructure 106 and, particularly, to a quantum annealer 114. The quantum annealer 114 may, in turn, determine, as part of a process performed by the quantum annealer 114 to solve an orchestration optimization problem, that the problem embodied in the user job 102 may be best resolved by a particular gate-based computing infrastructure that may comprise QPUs and/or vQPUs, such as the gate-based computing elements 112 for example. The gate-based computing infrastructure to which the problem is orchestrated by the quantum annealer 114 may then solve the problem.

### D. Detailed Description

Many decisions need to be made when orchestrating quantum jobs, whether they are run on real QPUs or classical quantum simulators. There are a variety of places where optimization can improve efficiency and job throughput, and many of these places involve resource allocation. In general, an embodiment may comprise the application of digital and/or quantum annealing processes to gate-based quantum computations. That is, an embodiment may employ annealing to solve problems that, absent the presence or availability of annealers, would otherwise be handled using gate-based methods and devices that may be less efficient and effective than annealers. In an embodiment, gate-based methods and devices may be determined to be better suited, than quantum methods and devices, to solve particular problems. As these examples thus illustrate, a computing infrastructure according to an embodiment may comprise various different types of computing resources, each of which may be relatively more effective and efficient than the others to solve particular problems. Thus, an embodiment may provide orchestration of a workload to whichever of the computing resources is determined, or deemed, most suitable for effective and efficient handling of that workload. Notably, a resource that may be best suited to solve a particular type of problem may also be capable of solving other problems for which that resource is not as well suited as other resources. Thus, a resource may be capable of optimal performance, as among a defined group of resources, for one type of problem, but may offer only sub-optimal performance, as among the group, for another type of problem.

One example embodiment of the invention is concerned with a use case involving the handling of quantum circuits. Particularly, circuit cutting, and circuit knitting, are ways of breaking down, and reassembling, large quantum circuits for execution on smaller QPUs, in part because smaller devices tend to have higher fidelity. That is, a better solution may be obtained by using a grouping of smaller devices, rather than a single large device. In an embodiment, circuit cutting may improve the QaaS (Quantum-as-a-Service) experience for developers, as circuit cutting may widen the field of possible cloud providers which can run the developer algorithms, and thus save money and/or make previously impossible circuits possible. Further information concerning circuit cutting may be found in [1] https://research.ibm.com/blog/circuit-knitting-with-classical-communication, and [2] https://arxiv.org/abs/2012.02333, both of which are incorporated herein in their respective entireties by this reference:

According to an embodiment, one operation in a circuit cutting and knitting procedure is identifying the ideal places to cut circuits, which may be between qubits which are less entangled than other pairs of qubits. In an embodiment, determining the answer to this may be performed using mixed integer programming (MIP). In some instances, such problems may be solved using the Gurobi optimization solver.

Notably, according to an embodiment, MIP problems may be solved using quantum/digital annealing processes and devices. Thus, according to an embodiment, one possible application of remote, or on-prem, annealing devices when servicing quantum workloads, is for those devices to serve as an MIP solver for obtaining circuit cutting solutions. Note that this approach is presented only by way of example and is not the sole possible approach that QUBO-enabled optimization may assist such orchestration.

As will be apparent from this disclosure, one or more embodiments may possess various useful features and aspects. A non-exhaustive list of examples of such features and aspects is set forth below. For example, an embodiment may operate to apply the strengths of annealing devices to gate-based quantum computation, and orchestration of QPU/vQPUs (virtual QPU). As another example, an embodiment may integrate one or more annealers, such as into a computing infrastructure, as a resource which may be allocated by an intermediate classical layer of a hybrid quantum computing approach. For example, an annealer may be allocated either for optimization by the orchestrator itself, or for executing an annealing-appropriate job submitted by an end user.

### E. Example Methods

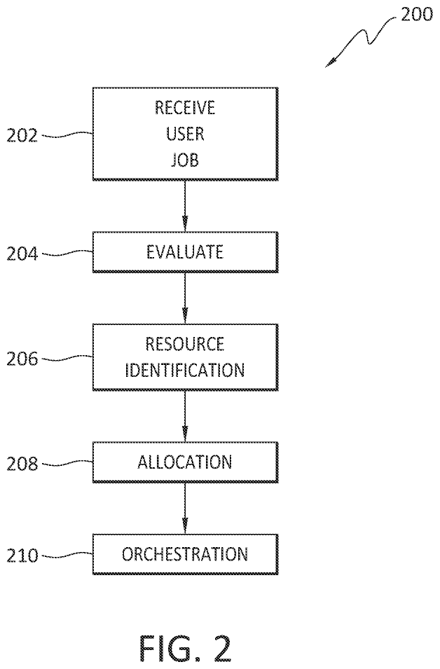

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

With attention now to FIG. 2, a method according to one example embodiment is denoted generally at 200. In an embodiment, the method 200 may be performed in an architecture such as is disclosed in FIG. 1, although no particular architecture is required.

The example method 200 may begin when a user job, such as a quantum computing workload, is received 202. In general, the quantum computing workload may be of a nature that it can be handled using gate-based quantum computations, or by an annealer, although, depending on the nature of the quantum workload, one or other of the gate-based approach or annealer approach may be better suited than the other, at least in terms of effectiveness and efficiency, to handle the quantum workload. In one particular embodiment, the quantum computing problem may comprise a problem which implies, as a prerequisite to solution of that problem, the solution, possibly by an annealer, of an orchestration optimization problem so as to determine where, that is, on what computing infrastructure, the quantum computing problem is to be solved.

Next, the particular nature of the quantum computing workload may be evaluated 204. For example, the evaluation 204 may reveal that the quantum computing workload comprises an MIP problem, such as may be best solved using an annealer. As another example, the evaluation 204 may reveal that the quantum computing workload comprises an NP-hard problem which may involve integer factorization and/or boolean satisfiability, which may be best solved using a gate-based device and approach.

Depending upon the outcome of the evaluation 204, an identification 206 may then be made as to the resource which is best suited, as among a defined group of resources, to execute the quantum workload. Thus, if the quantum computing workload is determined to comprise an MIP problem or QUBO for example, the resource for carrying out that quantum computing workload may be identified 206 as an annealer. As another example, if the quantum computing workload is determined to comprise an NP-hard problem for example, the resource for carrying out that quantum computing workload may be identified 206 as a gate-based device.

In an embodiment, the identification 206 may be performed by an annealer. In this example, the annealer may determine, for example, that a gate-based computing infrastructure is best suited to resolve the problem that is included in the quantum computing workload. Thus, the annealer in this example may operate to solve an orchestration optimization problem by determining the best resource to solve the underlying problem, while the underlying problem itself may be solved by whatever resource is identified by the annealer as the solution to the orchestration optimization problem.

After the resources have been identified 206, the resources may then be allocated 208 for execution of the quantum workload. At some point after the resources have been allocated 208, the quantum workload may then be orchestrated 210 to those resources for execution.

### F. Further Example Embodiments

Following are some further example embodiments of the invention. These are presented only by way of example and are not intended to limit the scope of the invention in any way.

Embodiment 1. A method, comprising: receiving a user job that comprises a quantum computing workload; evaluating the quantum computing workload; based on the evaluating, solving an orchestration optimization problem by identifying a computing resource for execution of the quantum computing workload, and the computing resource is selected from a defined group of computing resources of a computing infrastructure; and orchestrating the quantum computing workload to the computing resource for execution.

Embodiment 2. The method as recited in any preceding embodiment, wherein the defined group of computing resources comprises a classical computing resource, a gate-based computing resource, and an annealing resource.

Embodiment 3. The method as recited in any preceding embodiment, wherein the evaluating identifies a problem type of the computing workload.

Embodiment 4. The method as recited in any preceding embodiment, wherein, as between the computing resources of the defined group, the selected computing resource is best suited to execute the quantum computing workload.

Embodiment 5. The method as recited in any preceding embodiment, wherein more than one of the computing resources in the defined group is capable of executing the quantum computing workload.

Embodiment 6. The method as recited in any preceding embodiment, wherein the user job is received by an intermediate classical computing layer of a hybrid quantum computing configuration.

Embodiment 7. The method as recited in any preceding embodiment, wherein, prior to the orchestrating, the computing resource is allocated to the quantum computing workload.

Embodiment 8. The method as recited in any preceding embodiment, wherein the quantum computing workload comprises an optimization problem.

Embodiment 9. The method as recited in any preceding embodiment, wherein the computing resource to which the quantum computing workload is orchestrated comprises a gate-based quantum device.

Embodiment 10. The method as recited in any preceding embodiment, wherein the orchestration optimization problem is solved by an annealer.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In general, embodiments may comprise classical, and/or quantum, hardware and/or software. Quantum hardware may include, for example, physical qubits. Quantum circuits may comprise, for example, virtual qubits.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

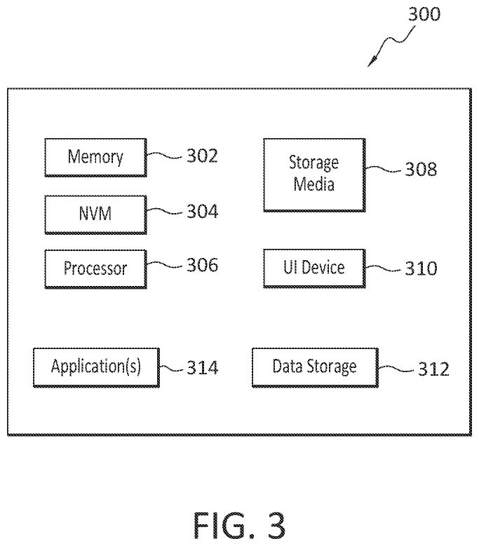

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a user job that comprises a quantum computing workload;
evaluating the quantum computing workload;
based on the evaluating, solving an orchestration optimization problem by identifying a computing resource for execution of the quantum computing workload, and the computing resource is selected from a defined group of computing resources of a computing infrastructure; and
orchestrating the quantum computing workload to the computing resource for execution.

2. The method as recited in claim 1, wherein the defined group of computing resources comprises a classical computing resource, a gate-based computing resource, and an annealing resource.

3. The method as recited in claim 1, wherein the evaluating identifies a problem type of the computing workload.

4. The method as recited in claim 1, wherein, as between the computing resources of the defined group, the selected computing resource is best suited to execute the quantum computing workload.

5. The method as recited in claim 1, wherein more than one of the computing resources in the defined group is capable of executing the quantum computing workload.

6. The method as recited in claim 1, wherein the user job is received by an intermediate classical computing layer of a hybrid quantum computing configuration.

7. The method as recited in claim 1, wherein, prior to the orchestrating, the computing resource is allocated to the quantum computing workload.

8. The method as recited in claim 1, wherein the quantum computing workload comprises an optimization problem.

9. The method as recited in claim 1, wherein the computing resource to which the quantum computing workload is orchestrated comprises a gate-based quantum device.

10. The method as recited in claim 1, wherein the orchestration optimization problem is solved by an annealer.

11. A non-transitory storage medium having stored therein instructions that are executable by one or more hardware processors to perform operations comprising:
receiving a user job that comprises a quantum computing workload;
evaluating the quantum computing workload;
based on the evaluating, solving an orchestration optimization problem by identifying a computing resource for execution of the quantum computing workload, and the computing resource is selected from a defined group of computing resources of a computing infrastructure; and
orchestrating the quantum computing workload to the computing resource for execution.

12. The non-transitory storage medium as recited in claim 11, wherein the defined group of computing resources comprises a classical computing resource, a gate-based computing resource, and an annealing resource.

13. The non-transitory storage medium as recited in claim 11, wherein the evaluating identifies a problem type of the computing workload.

14. The non-transitory storage medium as recited in claim 11, wherein, as between the computing resources of the defined group, the selected computing resource is best suited to execute the quantum computing workload.

15. The non-transitory storage medium as recited in claim 11, wherein more than one of the computing resources in the defined group is capable of executing the quantum computing workload.

16. The non-transitory storage medium as recited in claim 11, wherein the user job is received by an intermediate classical computing layer of a hybrid quantum computing configuration.

17. The non-transitory storage medium as recited in claim 11, wherein, prior to the orchestrating, the computing resource is allocated to the quantum computing workload.

18. The non-transitory storage medium as recited in claim 11, wherein the quantum computing workload comprises an optimization problem.

19. The non-transitory storage medium as recited in claim 11, wherein the computing resource to which the quantum computing workload is orchestrated comprises a gate-based quantum device.

20. The non-transitory storage medium as recited in claim 11, wherein the orchestration optimization problem is solved by an annealer.
